(19) United States
(12) Patent Application Publication
(10) Pub. No.: US 2024/0334903 A1
(43) Pub. Date: Oct. 10, 2024

(54) PET WASHING SYSTEM

(71) Applicant: Big Sky Dog Wash LLC, Billings, MT (US)

(72) Inventors: Lorne Armer, Billings, MT (US); Jack Klein, Billings, MT (US)

(21) Appl. No.: 18/131,114

(22) Filed: Apr. 5, 2023

(51) Int. Cl. A01K 13/00; E04H 1/12

(52) U.S. Cl. CPC A01K 13/001; E04H 1/1205

(57) ABSTRACT

A pet washing system with front and rear walls, two side walls, and a roof that is slanted downwardly from front to back. A dividing wall is between and parallel to the front and rear walls and between and perpendicular to the first and second side walls, thereby defining first and second areas within the rectangular structure. A first gap is situated directly underneath the bottom edge of the dividing wall between the dividing wall and the floor and configured to allow fluids to pass between the first area and the second area. A second gap is situated directly above the top edge of the dividing wall between the dividing wall and the ceiling. A plurality of louvres within the second gap is configured to allow air to pass between the first and second areas. The floor is slanted to direct liquids into a sump in the second area.

### BACKGROUND OF THE INVENTION

### 1. Field of the Invention

The present invention relates generally to the field of pet washing systems, and more particularly, to a self-contained, portable pet washing station.

### 2. Description of the Related Art

Currently, most dog owners are forced to wash their dogs at home (which creates a mess, clogs drains, etc.), wash their dogs outside (which is limited by weather and accessibility to a water source), or take their dogs to an existing pet wash business, which usually requires an appointment and is limited to normal business hours. A pet owner could hire a professional dog groomer, which may be cost-prohibitive for some owners. Furthermore, pet owners who wash their dogs on their own may use products that are not necessarily intended for use on dogs and that may be harmful to the dog's skin and/or coat. In addition, many pet owners are not aware of the effect of improper water temperature on the dog's skin or coat, nor are they aware of the effect of excessive heat when using blow dryers on their dogs.

Dog wash owner/operators are often faced with several challenges. One such challenge is locating suppliers for all of the elements needed to operate a successful business, and another challenge is meeting excessive regular maintenance requirements. Owner/operators may experience difficulties in the installation, placement and/or relocation of the pet washing unit. They may also find it difficult to comply with Americans With Disabilities Act (ADA) requirements, to control the ambient environment of the facility, and/or to address security issues.

The present invention solves all of these problems by providing a self-contained, portable dog wash system that contains the mess and handles dog hair and chemicals in a safe, environmentally controlled manner. Reservations are not required, and access is continuously available. Only veterinarian-approved products and veterinarian-approved water and air blower temperatures are used, thereby improving pet health and safety. The present invention incorporates a self-cleaning system with a centralized, easy to clean dog hair filter system. The present invention has an integrated under-body jack system for leveling and forklift access. It is a self-contained unit that fits on a standard flatbed trailer with no wide load requirements. The ambient environment is controlled with a centralized heating/cooling I unit and a fan that, together with the louvered air gap, maintains air flow circulation throughout the unit. The invention also incorporates security features such as lighting and locks, as described more fully in the Detailed Description of Invention below.

U.S. Patent Application Pub. No. 20120279456 (Caldwell) discloses a pet wash tub with a funnel-shaped arrangement formed by first and second panels that extend at an angle of greater than about ninety degrees relative to the floor, at an angle of greater than about ninety degrees relative to the first and second side walls, and at an angle of greater than ninety degrees relative to a third panel that is positioned behind the first and second panels. This funnel-shaped arrangement diverts water and dog hair through a drain hose and into a collection trough. The tub is situated within a pet wash station, which includes a wash room and an equipment room. The tub is located inside of the wash room, which has a sloped floor for diverting water into the collection trough. The equipment room includes a control panel and hose extensions for air and water/soap for washing a pet in the wash room.

U.S. Patent Application Pub. No. 20150000610 (Caldwell) discloses a compact self-service pet wash station with an equipment room and a foldable ash tub. The equipment room provides the means to control and supply the wash tub with rinse water, wash solution mix, and dry air to wash a pet in the wash tub. When in the storage position, the self-service pet wash station has a reduced dimension in a direction extending generally perpendicular to the axis of rotation and to gravity. The control unit, which controls the actuation of the water supply, forms part of the structure to which the foldable wash tub is mounted. The invention described in the '610 published application is intended to be incorporated into a bay for washing a car and is not a self-contained unit.

U.S. Patent Application Pub. No. 20050150467 (Jobal) provides a cleaning station with a glass enclosure in which the interior of the enclosure is disinfected with each washing procedure. The invention incorporates the use of hydraulics and a frequency variator/converter that is used to adjust the flow or air and water, as well as moisture and unpleasant odor extractors. The floor of the enclosure on which the animal is placed can swivel and fold and incorporates a load cell that detects the presence of the animal and prevents the disinfection process from taking place while the animal is inside of the enclosure. The hydraulic circuit controls the cleaning, rinsing and disinfection processes.

### BRIEF SUMMARY OF THE INVENTION

The present invention is a pet washing system comprising: a front wall; a first side wall; a second side wall; a rear wall; and a roof; wherein the front wall is attached to a first end of the first side wall and a first end of the second side wall, and the rear wall is attached to a second end of the first side wall and a second end of the second side wall, thereby forming a rectangular structure; wherein the roof is situated on top of the rectangular structure and is slanted so that the roof slopes downwardly from front to back; wherein a dividing wall is situated between and parallel to the front wall and the rear wall, and the dividing wall is situated between and perpendicular to the first side wall and the second side wall, thereby defining a first area and a second area within the rectangular structure; wherein the rectangular structure comprises a floor and a ceiling; wherein a first gap is situated directly underneath a bottom edge of the dividing wall between the bottom edge of the dividing wall and the floor and configured to allow fluids to pass between the first area and the second area; wherein a second gap is situated directly above a top edge of the dividing wall between the top edge of the dividing wall and the ceiling; wherein a plurality of louvres is situated within the second gap and configured to allow air to pass between the first area and the second area; wherein the floor extends from the front wall to the rear wall and from the first side wall to the second side wall; and wherein the floor is slanted to direct liquids into a sump that is situated in the second area.

In a preferred embodiment, the first area comprises: a front door configured to permit access into the first area; a wash tub that is situated in a corner of the first area between the second side wall and the rear wall; a platform that is configured to facilitate loading of an animal into and out of the wash tub; a liquid delivery hose that is configured to deliver liquids from the second area to the first area; an air dryer hose that is configured to deliver ambient or warm air to the first area from an air dryer that is located in the second area; and a vacuum hose that is configured to suck liquids and/or pet hair from the first area into a vacuum that is located in the second area; wherein the wash tub is slanted toward a drain hole in the dividing wall, the drain hole being connected to tubing that directs liquids from the wash tub into the sump. The first area preferably comprises a selection dial that is situated on the dividing wall and configured to allow a user to activate the vacuum, the air dryer, and/or one or more liquids to be delivered via the liquid delivery hose. Preferably, the invention further comprises a card reader that is configured to accept credit or debit card payments and to activate a timer.

In a preferred embodiment, the second area comprises: a side door configured to permit access into the second area; a packaged terminal air conditioner unit that is configured to provide heating and cooling to an interior of the second area and an interior of the first area by blowing warm or cool air through the second gap and allowing it to return via the first gap; one or more shelves that are situated along the second side wall; a water heater that is configured to deliver warm water to the first area via the liquid delivery hose; a water filter that is configured to deliver filtered water to the first area via the liquid delivery hose; and a pump that is situated in the sump and configured to pump liquids from the sump through a water outflow port. The dividing wall preferably comprises a compartment that is configured to receive a spray hose, and wherein the compartment is accessible from both the first area and the second area, and wherein a spigot is situated above the compartment in the second area and configured to deliver water to the spray hose. When both the front door and the side door are closed, the rectangular structure is preferably configured so that the only air flow into or out of the rectangular structure is through the packaged terminal air conditioner unit.

In a preferred embodiment, the louvres are slanted downwardly so as to direct air from the second area into the first area. In another preferred embodiment, the invention further comprises an auto-clean system, the auto-clean system being comprised of a plurality of pipes and nozzles that are configured to deliver water to the first area at a predetermined time or on demand. In one embodiment, the first area has two sides and a front, and the auto-clean system is configured to deliver water to the two sides and the front of the first area directly underneath the ceiling and to the front of the first area above floor level.

In a preferred embodiment, the rectangular structure comprises four bottom corners, further comprising a microleveler that is situated at each of the four bottom corners, the microleveler comprising: a male part that is telescopically coupled to and configured to slide up and down inside of a female part; and a ring that is configured to enable the rectangular structure to be hoisted onto and off of a flatbed trailer.

### BRIEF DESCRIPTION OF THE DRAWINGS

FIG. 1 is a first perspective view of the present invention.

FIG. 2 is a second perspective view of the present invention.

FIG. 3 is a front view of the present invention shown with the front door in an open position.

FIG. 4 is a rear view of the present invention.

FIG. 5 is a first side view of the present invention.

FIG. 6 is a top view of the present invention shown with the roof omitted for clarity.

FIG. 7 is a section view of the present invention taken at the line shown in FIG. 6.

FIG. 8 is a section view of the present invention taken at the line shown in FIG. 6.

FIG. 9 is a first perspective view of the present invention shown with the roof and walls omitted for clarity.

FIG. 10 is a second perspective view of the present invention shown with the roof and walls omitted for clarity.

FIG. 11 is a detail view of one of the micro-levelers of the present invention.

FIG. 12 is a detail view of the drain hole in the tub.

### REFERENCE NUMBERS

1 Front wall
2 First side wall
3 Second side wall
4 Rear wall
5 Roof
6 Drip edge (of roof)
7 Door (on front wall)
7a Handle (of door)
8 Window (on front wall)
9 Wash room
10 Equipment room
11 Micro-leveler
11a Male part (of micro-leveler)
11b Female part (of micro-leveler)
11c Ring
12 Window (on first side wall)
12a Drip guard (over window)
13 Door (on first side wall)
13a Drip guard (over door)
14 Packaged Terminal Air Conditioner (PTAC)
15 Light sensor
16 Electrical hookup
17 Electrical outlet
18a Water inflow port
18b Water outflow port
19 Exterior lights
20 Dividing wall
21 Floor
22 Wash tub
22a Front wall (of wash tub)
23 Platform
24 Liquid delivery hose
25 Air dyer
26 Vacuum
27 Control panel
27a Card reader
27b Timer
27c Selection dial
28 Compartment
29 Gap (at bottom of dividing wall)
30 Leash hook
31 Louvre
32 Drain hole (in wash tub)
33 Drain pipe
34 Sump
35 Control box
36 Container
37 Pump
38 Pipe
39 Nozzle
40 Water heater
41 Drain hole (in sump)
42 Water filter
43 Spigot
44 Electrical panel
45 Control panel (for auto-cleaning system)
46 Frame

### DETAILED DESCRIPTION OF INVENTION

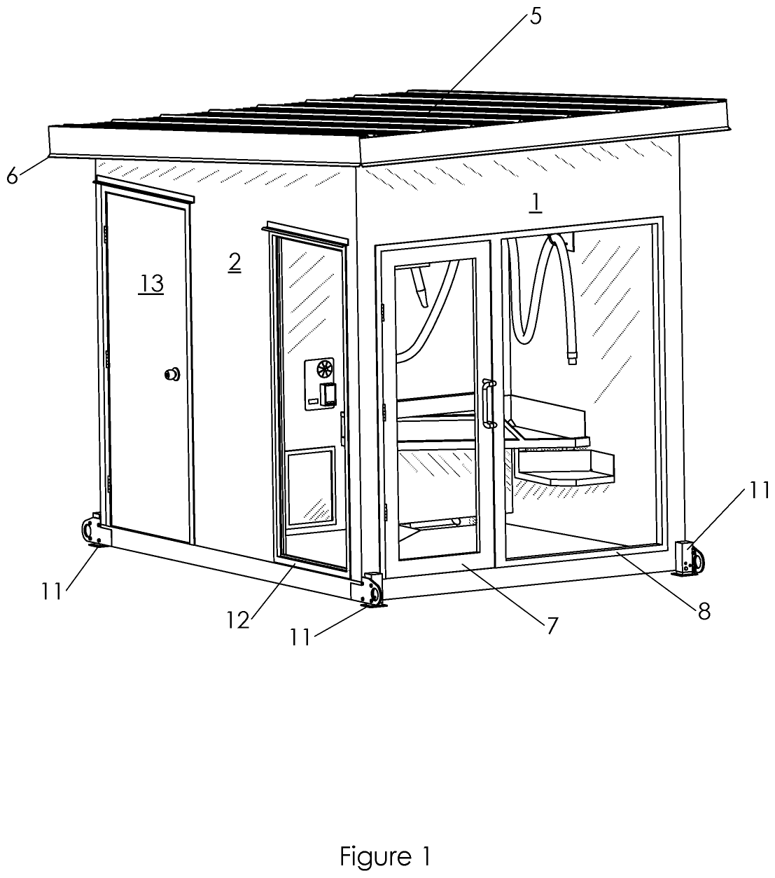

FIG. 1 is a first perspective view of the present invention. As shown in this figure, the present invention is a stand-alone structure comprised of a front wall 1, a first side wall 2, a second side wall 3, and a rear wall 4, all of which are configured to form a generally rectangular structure. As used herein, the term “rectangular” also includes square. The front wall 1 is taller than the rear wall 4, and the first and second side walls 2, 3 are taller at the front of the side wall than at the back of the side wall, thereby creating a slope on top of the structure from front to back. The present invention further comprises a roof 5, which is preferably made of corrugated steel. The roof 5 is sloped downwardly from front to back so that snow, ice and debris that may fall onto the roof is directed to the back of the structure and, by gravity, caused to fall off of the roof and onto the ground behind the structure. The roof 5 preferably comprises a drip edge 6 that extends outwardly around the bottom perimeter of the roof to direct snow and moisture away from the structure. The front, side and rear walls are preferably comprised of an insulated, breathable material such as the EZ Liner™ Interlocking Liner Panel manufactured by AmeriLux International of De Pere, Wisconsin. The frame 46 is preferably comprised of powder-coated aluminum.

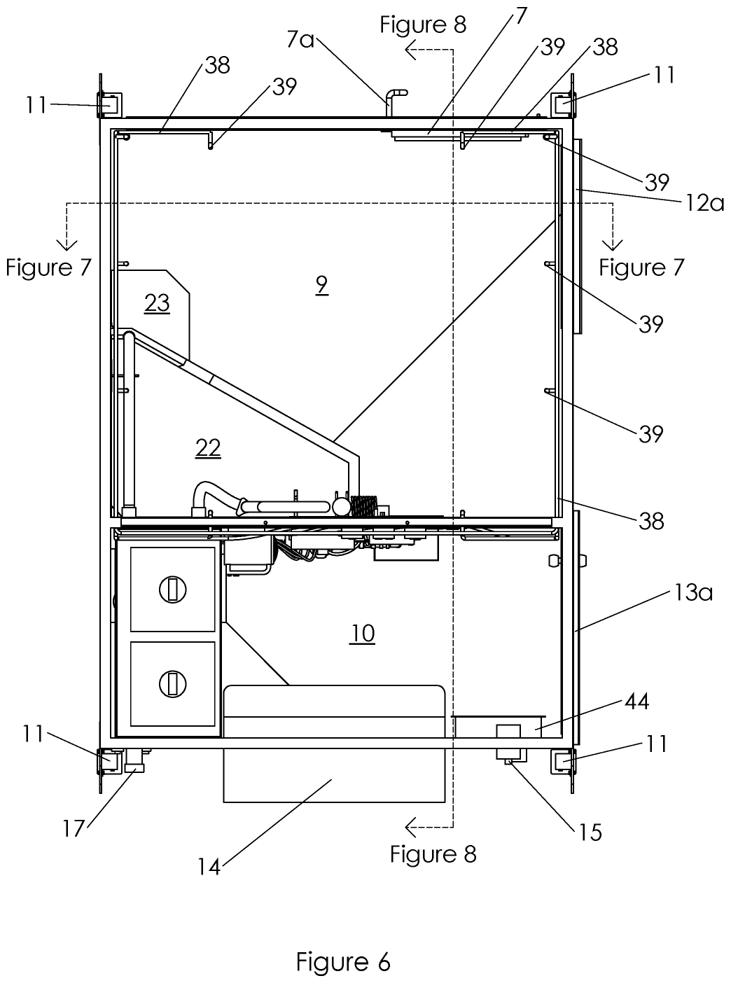

The front wall 2 comprises a door 7 and a window 8 that is situated next to the door and that is preferably the same height as the door. In a preferred embodiment, the door 7 is comprised of a transparent main panel so that nearly the entire front wall 2 provides a view into the inside of the wash room 9. The door also has a handle 7a(see also FIG. 6). As described more fully below, the structure comprises a wash room 9 and an equipment room 10. The equipment room is situated behind the wash room.

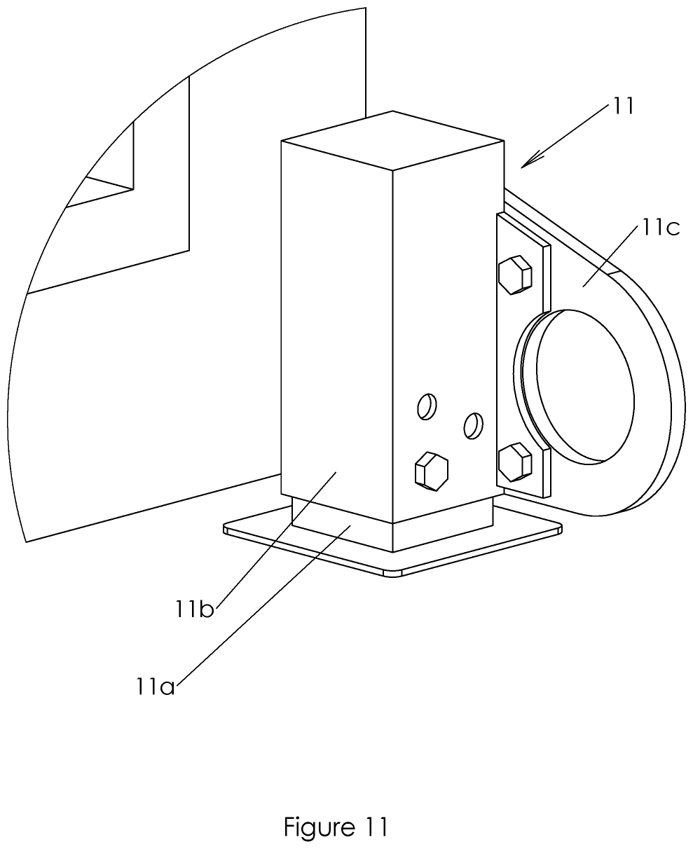

As shown in FIG. 1, a micro-leveler 11 is situated at each of the four corners of the structure where it meets the ground surface. Each micro-leveler 11 is configured to allow a corner of the structure to be raised or lowered based on the surface on which the structure is situated. The micro-leveler is shown in detail in FIG. 11. The first side wall 2 preferably comprises a window 12 that is preferably the same height as the front door 7 and window 8. Together, the front door 7 and windows 8, 12 provide visibility into nearly every aspect of the wash room 9 from outside of the structure, and they also allow the wash room 9 to be filled with natural light during the daytime. The first side wall 2 also comprises a door 13, which leads into the equipment room 10.

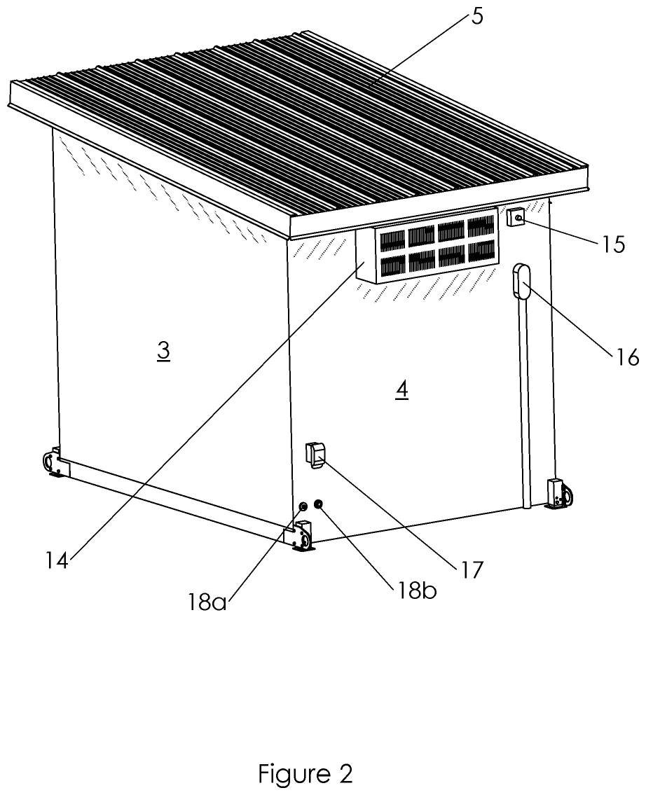

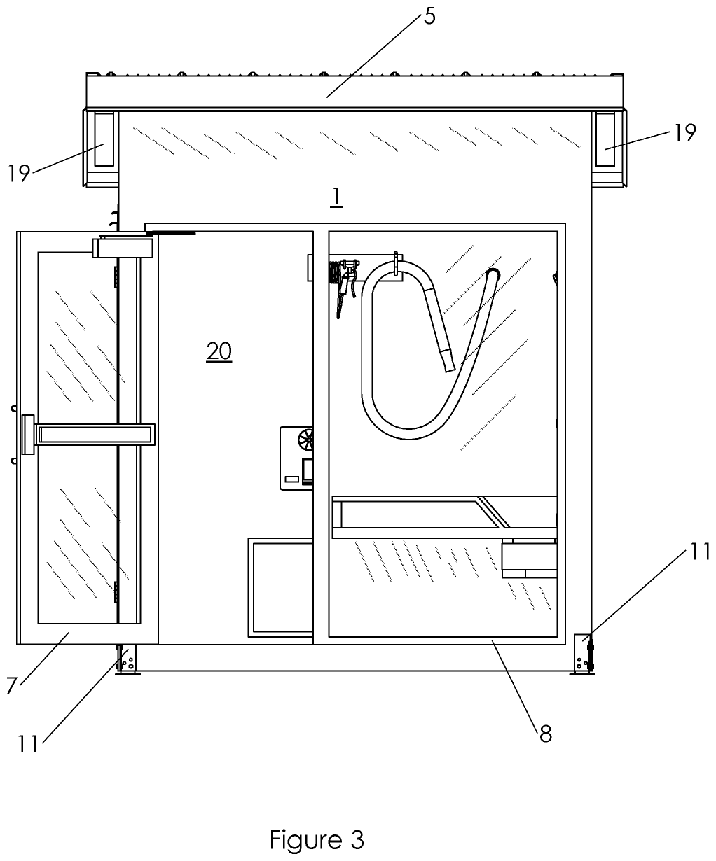

FIG. 2 is a second perspective view of the present invention. This figure shows the second side wall 3 and the rear wall 4. Situated at the top of the rear wall 4 is a packaged terminal air conditioner (PTAC) unit 14, which provides heating and cooling to the interior of the structure, as explained more fully below. Next to the PTAC unit is an ambient light sensor 15, which is configured to turn the exterior lights 19 on at night and turn them off during the day. The exterior lights 19 are situated around the perimeter of the roof, underneath the fascia, as required by building codes (see FIG. 3).

Also situated on the rear wall 4 is a standard electrical hookup 16 (or line box fitting) for the supply of power to the structure. On the left-hand side of the rear wall 4 toward the bottom of the rear wall is an exterior electrical outlet 17 for use in connection with other components that may require electricity, for example, heat tape. This figure also shows the water inflow 18a and outflow 18b ports. When the unit is in use, the water inflow 18a would be connected to a water supply (not shown), and the water outflow 18b would be connected to piping that transmits gray water to the sewer.

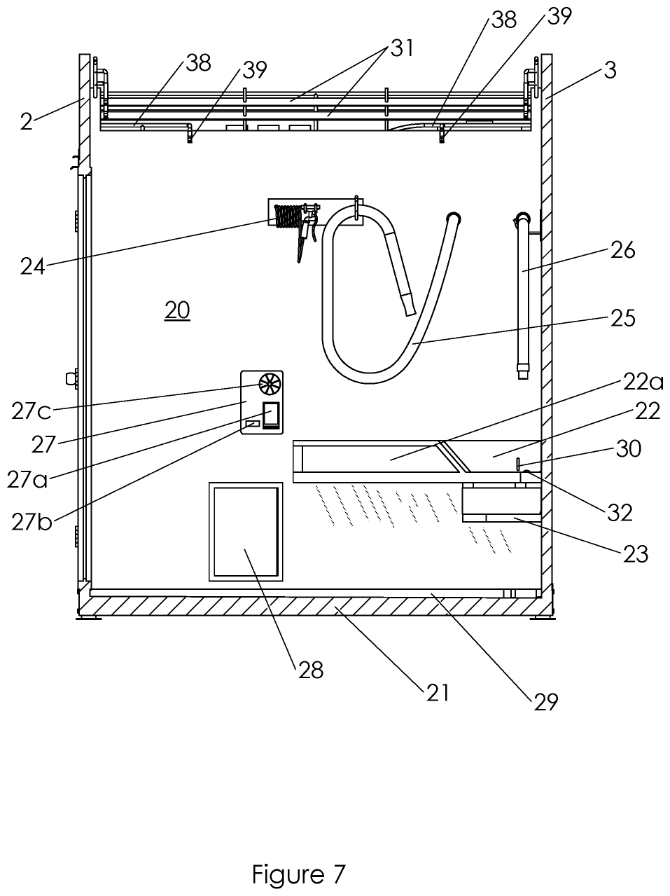

FIG. 3 is a front view of the present invention shown with the front door in an open position. As shown in this figure, the front door 7 leads into the wash room 9, which is separated from the equipment room 10 by a dividing wall 20. As shown in FIG. 7, there is a gap at the bottom and at the top of the dividing wall. These gaps serve important functions, as explained below.

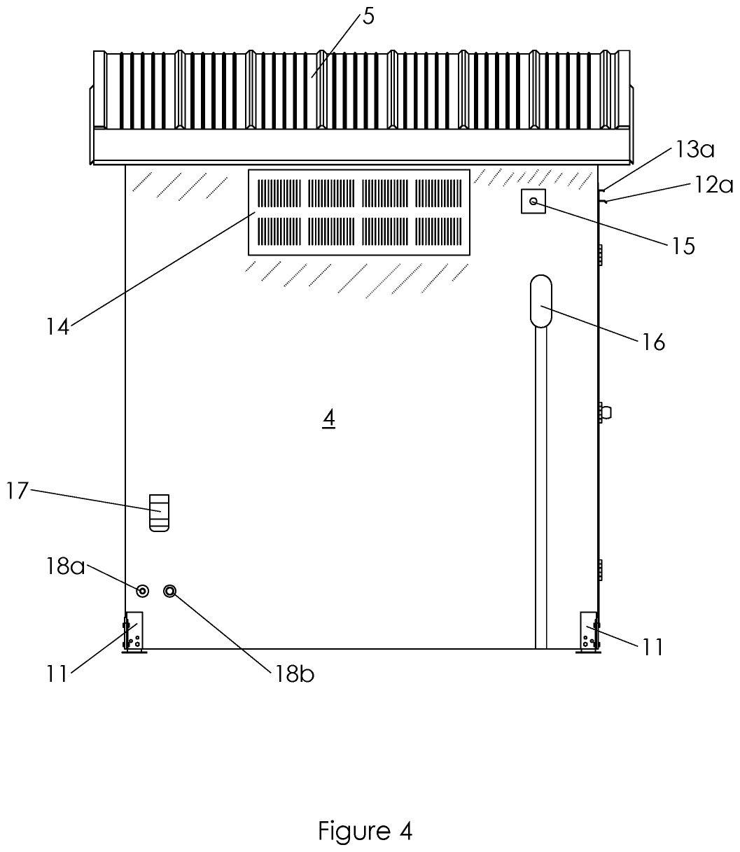

FIG. 4 is a rear view of the present invention. All parts shown in this figure have been previously referenced, which the exception of the drip guard 12a over the window and the drip guard over the door 13a, which are shown here.

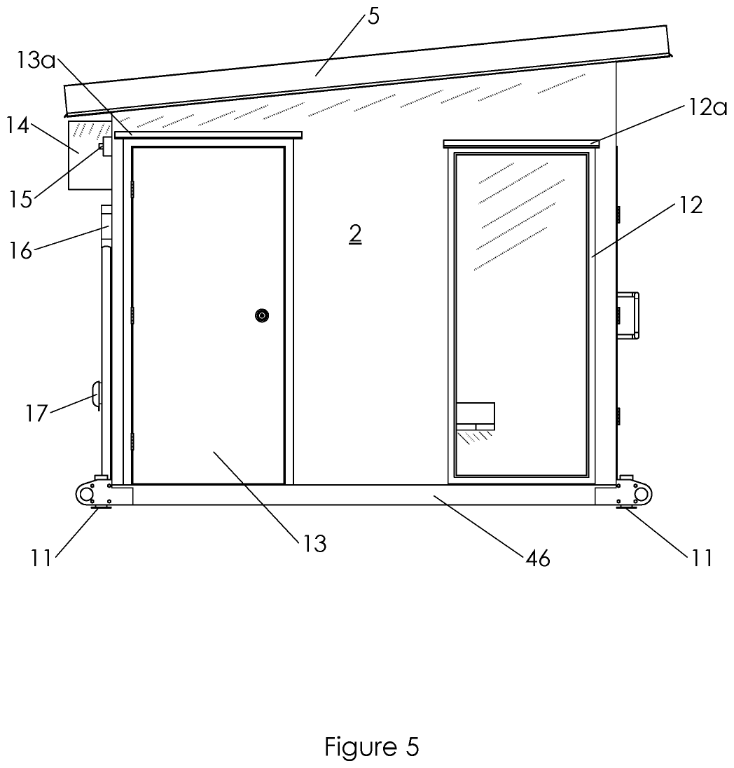

FIG. 5 is a first side view of the present invention. The door 13 is preferably opaque because it would not be desirable to have the contents of the equipment room visible to the public. The entire structure is supported by a floor 21 that extends from front wall 1 to rear wall 4 and from first side wall 2 to second side wall 3. The wash room 9 and the equipment room 10 share the same floor 21. From wall to wall and floor to roof, the entire structure is sealed so that no precipitation can enter the structure, and no person or animal can enter into or exit from the structure other than via the doors 7, 13. With the door closed, the only air flow into or out of the invention is through the PTAC unit.

FIG. 6 is a top view of the present invention shown with the roof omitted for clarity. In a preferred embodiment, the footprint of the wash room 9 is preferably larger than that of the equipment room 10. As shown in this figure, the wash room 9 comprises a wash tub 22 for washing an animal and a platform 23 that is configured to allow the animal to step up into the wash tub 22. The floor of the platform 23 and the floor of the wash tub 22 are preferably covered by a rubber, no-slip mat (not shown). The wash tub 22 preferably comprises a front wall 22a to prevent spillage or overspray into the wash room or onto the pet owner. The present invention comprises an auto-cleaning system of pipes 38 and nozzles 39 that are configured to deliver water to the wash room 9 at a predetermined time or on demand, as described more fully below. A standard electrical panel 44 is situated inside of the equipment room 10 on the rear wall 4. As shown in this figure, the wash tub 22 is preferably configured so that one wall of the tub is the side wall 3, and another wall of the tub is the dividing wall 20. In a preferred embodiment, the wash tub 22 is situated in a corner of the wash room 9 and extends from a point in approximately the center of that part of the side wall 3 that constitutes the wash room 9 to a point in approximately the center of the dividing wall 20, thereby spanning a corner of the wash room and creating a footprint that is more or less triangular.

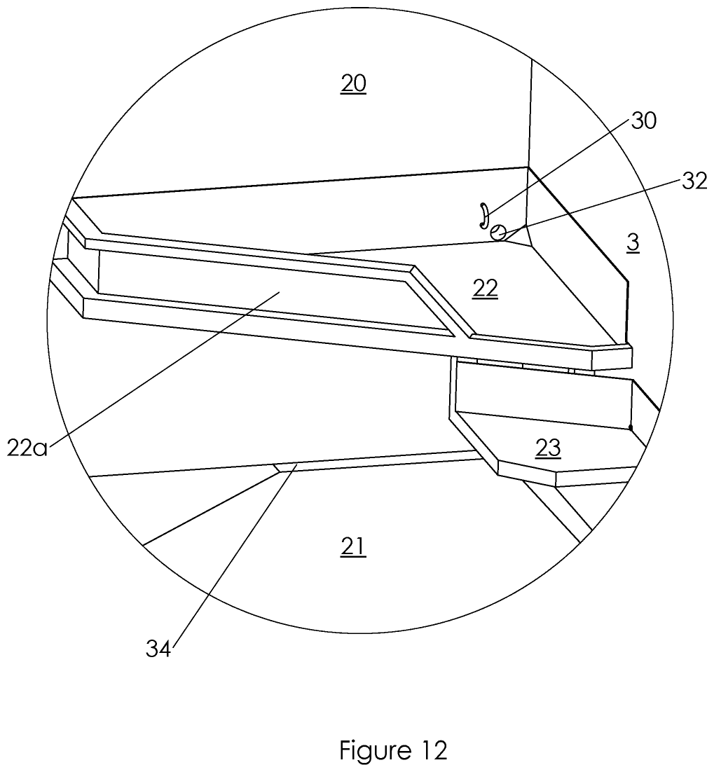

FIG. 7 is a section view of the present invention taken at the line shown in FIG. 6. As shown in this figure, the wash room 9 includes several components that may be used by customers to wash and dry an animal in the wash tub 22 or on the floor of the wash room. These components include a liquid delivery hose 24, an air dryer 25, and a vacuum 26. The liquid delivery hose 24 is configured to deliver water, soap, disinfectant, or flea and tick, depending on which product is selected on the selection dial 27c. The air dryer 25 is configured to deliver either warm air or air at ambient temperature to be used by the pet owner to dry the animal after washing. The vacuum 26 is used to suck up water, hair and any other debris from the wash tub 22 or wash room 9. The wash tub 22 preferably comprises a hook 30 for attaching a leash. The wash tub 22 is slanted downwardly toward a drain hole 32 that is situated in the right, rear corner of the wash tub (see also FIG. 12). Note that the front wall 22a does not extend over that part of the wash tub 22 that is situated directly over the platform 23.

A control panel 27 is situated on the dividing wall 20. The control panel 27 includes a card reader 27a for credit or debit card payments, a timer 27b (which counts the time available to the user), and a selection dial 27c. The selection dial 27c allows the user to select rinse, shampoo, conditioner, flea and tick, vacuum, dryer, or disinfectant, thereby controlling which component is activated and which product is delivered via the liquid delivery hose 24. In an alternate embodiment, the card reader 27a may be situated on the outside of the structure so that a customer would have to enter a credit or debit card before entering the wash room. Also situated on the dividing wall 20 is a compartment 28 that contains a spray hose (not shown). This spray hose may be used by the owner/operator to further spray down and clean the wash room 9.

As shown in FIG. 7, the dividing wall 20 stops short of the floor 21 so that there is a gap 29 between the bottom edge of the dividing wall 20 and the floor 21. This gap increases from left to right in FIG. 7 because the floor is slanted downwardly and rearwardly toward the right rear corner of the wash room 9. In this manner, liquid and debris from the cleaning process is directed toward the same corner of the wash room and into a sump 34 that is situated in the floor of the equipment room 10. This gap 29 is also important in maintaining air flow between the wash room 9 and the equipment room 10.

It is also important to note that the dividing wall 20 does not extend to the ceiling of the wash/equipment rooms. Instead, there is a gap between the top edge of the dividing wall 20 and the ceiling of the structure (the ceiling is not shown in this figure because the roof has been omitted for clarity). Situated within this gap are one or more louvres 31. These louvres 31 extend from the first side wall 2 to the second side wall 3 and are slanted downwardly in order to direct warm air (during the winter) or cold air (during the summer) from the equipment room 10 into the wash room 9. This air then circulates throughout the wash room 9, creating an air current that recirculates the air back into the equipment room 10 through the gap 29 at the bottom of the dividing wall. In this manner, the dividing wall 20 acts as a temperature regulator, sending warm or cool air into the wash room 9 and allowing it to return to the equipment room 10, where it is once again warmed or cooled, sent into the wash room, etc. The floor 21 is preferably overlaid with a durable, waterproof mat (such as non-slip vinyl flooring) that is suitable for foot traffic and easy to clean.

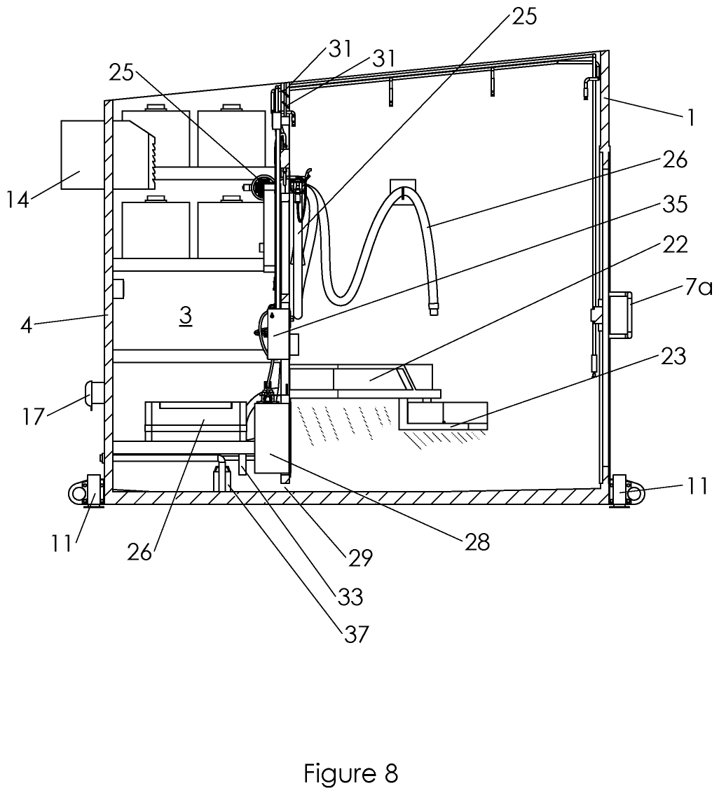

Note that the PTAC unit 14 is situated on the rear wall 4 at the same level as or slightly lower than the louvres 31 (see FIG. 8). As shown in FIG. 8, the PTAC unit 14 comprises a diagonal face that is pointed upwardly and configured to blow warm or cool air from the PTAC unit directly onto the louvres. This placement of the PTAC unit 14 is important in creating and maintaining the air flow between the equipment room 10 and the wash room 9. The front face of the PTAC unit 14 sucks return air back into the PTAC unit, including air entering the equipment room 10 from the wash room 9 via the gap 29 at the bottom of the dividing wall 20. The PTAC unit 14 is configured to vent to the rear of the rectangular structure (see FIG. 4).

FIG. 8 is a section view of the present invention taken at the line shown in FIG. 6. This figure shows the contents of the equipment room 10. In a preferred embodiment, the equipment room 10 comprises two shelves for supporting containers 36 of liquid product (shampoo, conditioner, flea and tick, and disinfectant), one shelf for supporting the vacuum 26, and another shelf for storing miscellaneous items. These shelves are situated on the inside of the second side wall 3. The vacuum 26 is preferably situated on the lowest shelf so that it can be configured to drain into the sump 34 if need be. A drain pipe 33 extends from the drain hole 32 in the wash tub 22 and is configured to deposit liquids into the sump 34. This figure shows the spray hose compartment 28 and the electrical box 35, which contains the processor that controls all of the various solenoid valves (for delivering liquid product) and other operational functions (such as the air dryer, vacuum and timer). It also shows the air dryer 25. The PTAC 14 supplies warm or cool air to the equipment room 10. A pump 37 is situated in the sump 34 and configured to pump liquids from the sump through the water outflow port 18b.

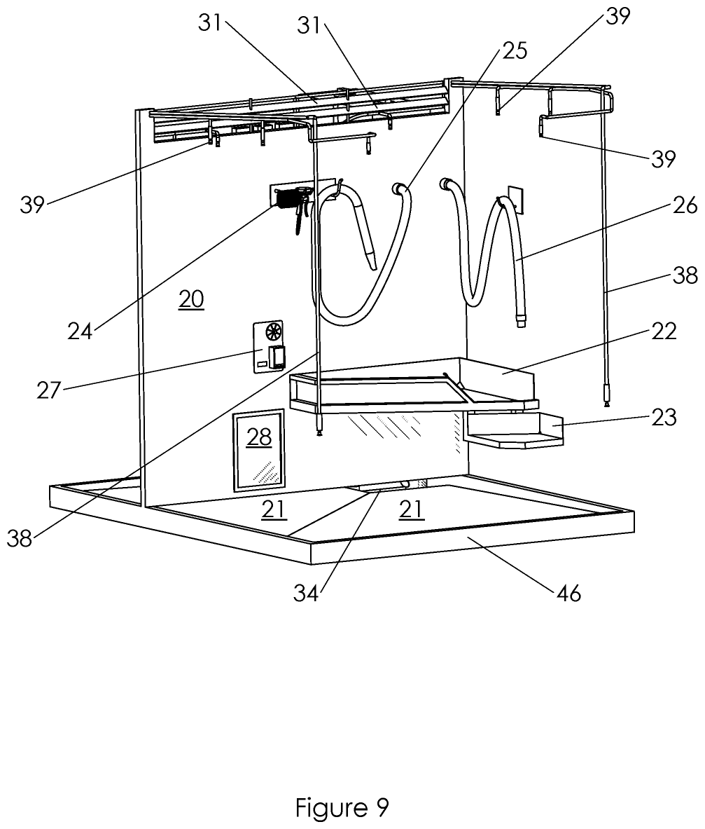

FIG. 9 is a first perspective view of the present invention shown with the roof and walls omitted for clarity. This figure clearly shows the slant in the floor 21, which directs all liquid waste into the rear right-hand corner of the wash room 9, where it flows through the gap at the bottom of the dividing wall 20, and into the sump 34 in the equipment room 10. This figure also clearly shows the auto-cleaning system, which is configured to deliver water to both sides and the front of the wash room just underneath the ceiling and also to the front of the wash room above floor level. In a preferred embodiment, the auto-cleaning system is set to run in the middle of the night when customers would be unlikely to use the unit.

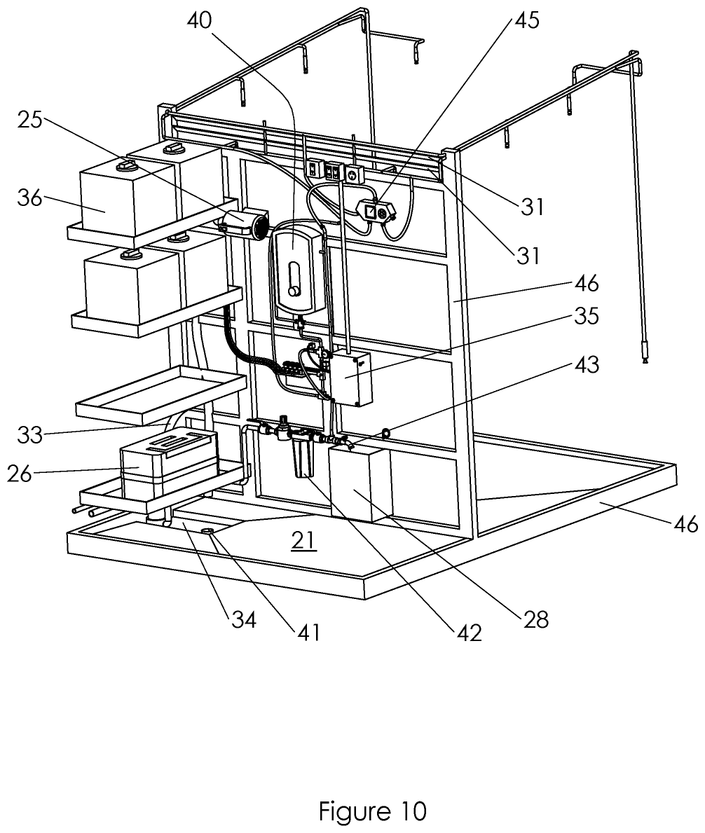

FIG. 10 is a second perspective view of the present invention shown with the roof and walls omitted for clarity. As shown in this figure, the floor 21 of the equipment room 10 is preferably also slanted to drain any liquids on the floor into the sump 34. The sump comprises a drain hole 41 that allows the liquids in the sump to drain to ground via a pipe (not shown) in the event that the pump 37 malfunctions. The equipment room 10 also houses a water heater 40 and a water filter 42, both of which are preferably situated on the dividing wall 20. The water heater is configured to heat the water that is delivered via the liquid delivery hose 24 (with or without product mixed into it) so that the animal is not washed in uncomfortably cold water. The water filter 42 is configured to filter the water as it enters the system from the water inflow port 18a. From the water filter 42, the unheated water may pass through a spigot 43 that is positioned directly over the spray hose compartment 28. The spigot 43 would typically be connected to a spray hose (not shown). Also situated on the dividing wall 20 inside of the equipment room 10 is the control panel 45 for the auto-cleaning system. Although the water heater 40 is shown as installed on the dividing wall 20 in this figure, it may be placed anywhere in the equipment room 10, including on a shelf.

FIG. 11 is a detail view of one of the micro-levelers of the present invention. As shown in this figure, each micro-leveler is comprised of a male part 11a that is configured to slide up and down inside of a female part 11b; in other words, the male part 11a and the female part 11b are telescopically coupled. The position of the male part relative to the female part 11b is secured with a bolt. The micro-leveler also comprises a ring 11c that is used to hoist the unit onto and off of a flatbed trailer.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A pet washing system comprising:
a front wall;
a first side wall;
a second side wall;
a rear wall; and
a roof;
wherein the front wall is attached to a first end of the first side wall and a first end of the second side wall, and the rear wall is attached to a second end of the first side wall and a second end of the second side wall, thereby forming a rectangular structure;
wherein the roof is situated on top of the rectangular structure and is slanted so that the roof slopes downwardly from front to back;
wherein a dividing wall is situated between and parallel to the front wall and the rear wall, and the dividing wall is situated between and perpendicular to the first side wall and the second side wall, thereby defining a first area and a second area within the rectangular structure;
wherein the rectangular structure comprises a floor and a ceiling;
wherein a first gap is situated directly underneath a bottom edge of the dividing wall between the bottom edge of the dividing wall and the floor and configured to allow fluids to pass between the first area and the second area;
wherein a second gap is situated directly above a top edge of the dividing wall between the top edge of the dividing wall and the ceiling;
wherein a plurality of louvres is situated within the second gap and configured to allow air to pass between the first area and the second area;
wherein the floor extends from the front wall to the rear wall and from the first side wall to the second side wall; and
wherein the floor is slanted to direct liquids into a sump that is situated in the second area.

2. The pet washing system of claim 1, wherein the first area comprises:
a front door configured to permit access into the first area;
a wash tub that is situated in a corner of the first area between the second side wall and the rear wall;
a platform that is configured to facilitate loading of an animal into and out of the wash tub;
a liquid delivery hose that is configured to deliver liquids from the second area to the first area;
an air dryer hose that is configured to deliver ambient or warm air to the first area from an air dryer that is located in the second area; and
a vacuum hose that is configured to suck liquids and/or pet hair from the first area into a vacuum that is located in the second area;
wherein the wash tub is slanted toward a drain hole in the dividing wall, the drain hole being connected to tubing that directs liquids from the wash tub into the sump.

3. The pet washing system of claim 2, wherein the first area comprises a selection dial that is situated on the dividing wall and configured to allow a user to activate the vacuum, the air dryer, and/or one or more liquids to be delivered via the liquid delivery hose.

4. The pet washing system of claim 1, further comprising a card reader that is configured to accept credit or debit card payments and to activate a timer.

5. The pet washing system of claim 2, wherein the second area comprises:
a side door configured to permit access into the second area;
a packaged terminal air conditioner unit that is configured to provide heating and cooling to an interior of the second area and an interior of the first area by blowing warm or cool air through the second gap and allowing it to return via the first gap;
one or more shelves that are situated along the second side wall;
a water heater that is configured to deliver warm water to the first area via the liquid delivery hose;
a water filter that is configured to deliver filtered water to the first area via the liquid delivery hose; and
a pump that is situated in the sump and configured to pump liquids from the sump through a water outflow port.

6. The pet washing system of claim 1, wherein the dividing wall comprises a compartment that is configured to receive a spray hose, and wherein the compartment is accessible from both the first area and the second area, and wherein a spigot is situated above the compartment in the second area and configured to deliver water to the spray hose.

7. The pet washing system of claim 5, wherein when both the front door and the side door are closed, the rectangular structure is configured so that the only air flow into or out of the rectangular structure is through the packaged terminal air conditioner unit.

8. The pet washing system of claim 1, wherein the louvres are slanted downwardly so as to direct air from the second area into the first area.

9. The pet washing system of claim 1, further comprising an auto-clean system, the auto-clean system being comprised of a plurality of pipes and nozzles that are configured to deliver water to the first area at a predetermined time or on demand.

10. The pet washing system of claim 9, wherein the first area has two sides and a front, and the auto-clean system is configured to deliver water to the two sides and the front of the first area directly underneath the ceiling and to the front of the first area above floor level.

11. The pet washing system of claim 1, wherein the rectangular structure comprises four bottom corners, further comprising a microleveler that is situated at each of the four bottom corners, the microleveler comprising:
a male part that is telescopically coupled to and configured to slide up and down inside of a female part; and
a ring that is configured to enable the rectangular structure to be hoisted onto and off of a flatbed trailer.
